(19) United States
(12) Patent Application Publication
(10) Pub. No.: US 2026/0148918 A1
(43) Pub. Date: May 28, 2026

(54) Data Cable With Memory Alloy Wire

(71) Applicant: Shenzhen Jike Innovation Technology Co., Ltd., ShenZhen (CN)

(72) Inventor: Shaolin Su, ShenZhen (CN)

(73) Assignee: Shenzhen Jike Innovation Technology Co., Ltd., ShenZhen (CN)

(21) Appl. No.: 18/963,583

(22) Filed: Nov. 28, 2024

(51) Int. Cl. H01H 37/32; H01H 37/52

(52) U.S. Cl. CPC H01H 37/323; H01H 37/52

(57) ABSTRACT

A data cable with memory alloy wire is disclosed, including a first conductive section and a second conductive section. The second conductive section includes a memory alloy wire consist of a first memory alloy wire and a second memory alloy wire, and the first memory alloy wire and is linked with the second memory alloy wire. By using the first memory alloy wire and the second memory alloy wire, it can achieve electrical conductivity and disconnection between the second conductive section and the first conductive section, achieving automatic conduction and disconnection of the data cable.

### TECHNICAL FIELD

The present application relates to a data cable with memory alloy wire.

### BACKGROUND

Data cable is a cable used to charge or transmit data to electronic devices, and is often used in daily life. The data cable will generate heat during use, which will affect charging or data transmission, and may even cause safety issues.

### SUMMARY

In view of this, the present disclosure is necessary to provide a data cable with memory alloy wire that will automatically disconnect when reaching a certain temperature and automatically connect when below a specific temperature.

In some embodiments of the present disclosure, the present disclosure provides a data cable with memory alloy wire, including a first conductive section and a second conductive section. Herein the second conductive section comprises a memory alloy wire consist of a first memory alloy wire and a second memory alloy wire, and the first memory alloy wire is linked with the second memory alloy wire. Moreover, a memory deformation temperature of the first memory alloy wire is less than that of the second memory alloy wire, the first memory alloy wire maintains a memory shape at room temperature to make the second conductive section electrically conductive with the first conductive section, and the second memory alloy wire disconnects the second conductive section from the first conductive section under the memory shape.

The data cable with memory alloy wire of the present disclosure has at least the following beneficial effects and advantages. During use of the data cable, if the temperature is lower than the memory deformation temperature of the second memory alloy wire, the second memory alloy wire will drive the first memory alloy wire to recover to the memory shape of the second memory alloy wire, causing the second conductive section to disconnect from the first conductive section, so that the electrical connection inside the data cable is disconnected, and the data cable will no longer work. And when the temperature naturally decreases below the memory deformation temperature of the second memory alloy wire, the first memory alloy wire will drive the second memory alloy wire to recover to the memory shape of the first memory alloy wire, making the second conductive section conductive with the first conductive section and allowing the data cable to continue working.

### BRIEF DESCRIPTION OF THE DRAWINGS

FIG. 1 shows a structural schematic diagram of a data cable with memory alloy wire in accordance with some embodiments of the present disclosure.

FIG. 2 shows a structural schematic diagram when a second conductive section is disconnected from a first conductive section in accordance with some embodiments of the present disclosure.

FIG. 3 shows a structural schematic diagram when the second conductive section is connected to the first conductive section in accordance with some embodiments of the present disclosure.

FIG. 4 shows a structural schematic diagram when the second conductive section is disconnected from the first conduction section in accordance with some embodiments of the present disclosure.

FIG. 5 shows a structural schematic diagram when the second conductive section is connected with the first conductive section in accordance with some embodiments of the present disclosure.

### DETAILED DESCRIPTION OF THE EMBODIMENTS

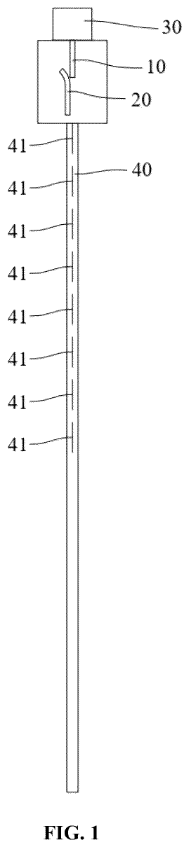

As shown in FIG. 1 to FIG. 5, in some embodiments of the present disclosure, it provides a data cable with memory alloy wire, including a first conductive section 10 and a second conductive section 20. Herein the first conductive section 10 is connected to a connector 30 of the data cable, the second conductive section 20 is connected to a line body 40 of the data cable, or the first conductive section 10 is connected to the line body 40 of the data cable and the second conductive section 20 is connected to the connector 30.

The second conductive section 20 includes a memory alloy wire consist of a first memory alloy wire 21 and a second memory alloy wire 22, and the first memory alloy wire 21 is linked with the second memory alloy wire 22, for example, they can be wrapped, tied, or glued together.

A memory deformation temperature of the first memory alloy wire 21 is less than the memory deformation temperature of the second memory alloy wire 22, and the first memory alloy wire 21 maintains a memory shape at room temperature to make the second conductive section 20 electrically conductive with the first conductive section 10. Furthermore, the second memory alloy wire 22 disconnects the second conductive section 20 from the first conductive section 10 under the memory shape.

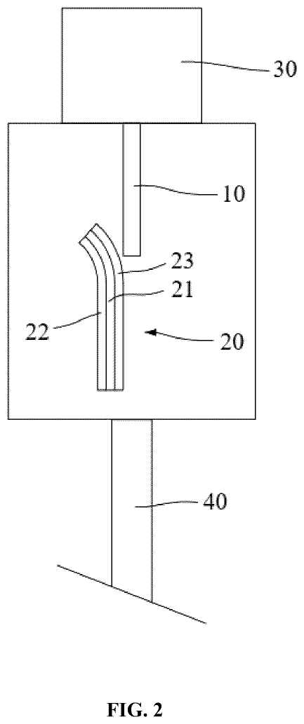

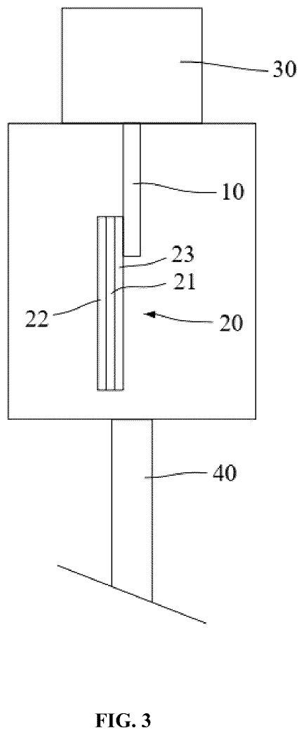

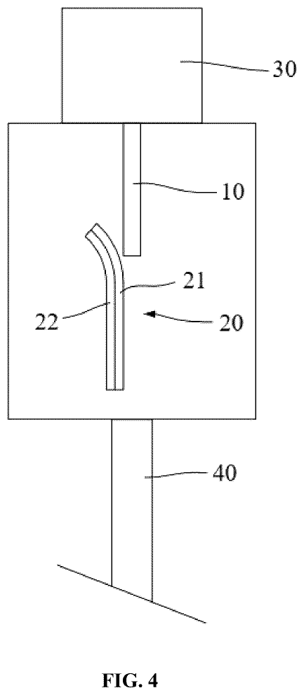

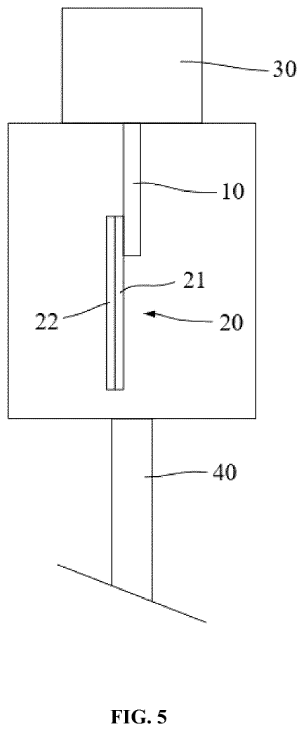

Referring to FIG. 2 and FIG. 4, during the use of the data cable, if the temperature is lower than the memory deformation temperature of the second memory alloy wire 22, the second memory alloy wire 22 will drive the first memory alloy wire 21 to recover to the memory shape of the second memory alloy wire 22, causing the second conductive section 20 to disconnect from the first conductive section 10, so that the electrical connection inside the data cable is disconnected, and the data cable will no longer work. Referring to FIG. 3 and FIG. 5, when the temperature naturally decreases below the memory deformation temperature of the second memory alloy wire 22, the first memory alloy wire 21 will drive the second memory alloy wire 22 to recover to the memory shape of the first memory alloy wire 21, making the second conductive section 20 conductive with the first conductive section 10 and allowing the data cable to continue working.

Referring to FIG. 2 and FIG. 3, in some embodiments of the present disclosure, the second conductive section 20 includes a wire 23, and the wire 23 is linked together with the first memory alloy wire 21 and the second memory alloy wire 22. Moreover, the wire 23 is in contact with the first conductive section to establish electrical conductivity between the second conductive section 20 and the first conductive section 10.

Referring to FIG. 4 and FIG. 5, in some other embodiments of the present disclosure, the first memory alloy wire 21 and/or the second memory alloy wire 22 are/is in contact with the first conductive section 10 to establish electrical conductivity between the second conductive section 20 and the first conductive section 10.

During the use of the data cable, the temperature near the connector 30 will be higher, and the temperature farther away from the connector 30 will be lower, making it easier to store the data cable (For example, it can be curled or folded for storage). Continuing to refer to FIG. 1, the memory alloy wire may include a plurality of memory alloy wire segments 41, the memory alloy wire segments 41 are sequentially arranged along a length direction of the line body 40 of the data cable, and the memory alloy wire segments 41 may be connected or spaced apart, with the memory deformation temperature of the memory alloy wire segments 41 farther away from the connector 30 of the data cable is smaller. When using the data cable, the memory alloy wire segments 41 can simultaneously reach a corresponding deformation temperature, allowing the memory alloy wire segments 41 to simultaneously restore to their corresponding memory shapes, thereby completing the automatic storage of the data cable.

What is claimed is:

1. A data cable with memory alloy wire, comprising:
a first conductive section; and
a second conductive section;
wherein the second conductive section comprises a memory alloy wire consist of a first memory alloy wire and a second memory alloy wire, and the first memory alloy wire and is linked with the second memory alloy wire; and
wherein a memory deformation temperature of the first memory alloy wire is less than that of the second memory alloy wire, the first memory alloy wire maintains a memory shape at room temperature to make the second conductive section electrically conductive with the first conductive section, and the second memory alloy wire disconnects the second conductive section from the first conductive section under the memory shape.

2. The data cable with memory alloy wire according to claim 1, wherein the second conductive section comprises a wire, and the wire is linked together with the first memory alloy wire and the second memory alloy wire; and wherein the wire is in contact with the first conductive section to establish electrical conductivity between the second conductive section and the first conductive section.

3. The data cable with memory alloy wire according to claim 1, wherein the first memory alloy wire and the second memory alloy wire are in contact with the first conductive section to establish electrical conductivity between the second conductive section and the first conductive section; alternatively, the first memory alloy wire or the second memory alloy wire is in contact with the first conductive section to establish electrical conductivity between the second conductive section and the first conductive section.

4. The data cable with memory alloy wire according to claim 1, wherein the memory alloy wire comprises a plurality of memory alloy wire segments, the memory alloy wire segments are sequentially arranged along a length direction of a line body of the data cable; and wherein the memory deformation temperature of the memory alloy wire segments farther away from a connector of the data cable is smaller.
